(19) United States
(12) Patent Application Publication
(10) Pub. No.: US 2010/0240413 A1
(43) Pub. Date: Sep. 23, 2010

(54) Smart Card File System

(75) Inventors: Jialin He, Redmond, WA (US); Michael B. Jones, Redmond, WA (US); Arun K. Nanda, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/408,697

(22) Filed: Mar. 21, 2009

(51) Int. Cl. H04M 1/00; G06F 13/00; G06F 17/30; G06F 9/54; G06F 12/00

(52) U.S. Cl. 455/558; 719/328; 707/E17.01; 711/115

(57) ABSTRACT

An application programming interface (API) may receive high level file commands and implement those commands using the storage mechanism on a smart card. The smart card may have a processor and storage mechanism and may communicate to a host device using a packet based communication protocol, such as ADPU. The API may translate the high level file commands into one or more ADPU commands, communicate with the smart card, receive APDU responses, and translate the responses into high level file commands. A high level file command may allow access to a file using long file names, a hierarchical directory structure, and may allow creating, writing, reading, and deleting a file. Some embodiments may have more complex functions for navigating and manipulating a hierarchical directory structure, as well as defining metadata including access privileges and file types to individual files.

### BACKGROUND

Smart card technologies, such as cards defined in ISO/IEC 7816 and ISO/IEC 7810, are examples of small devices that contain both a small processor and a mechanism to store data. In many implementations, the processor may perform various cryptographic processes that may be used to authenticate and identify the smart card. Typically, the storage mechanism may be used to store a cryptographic key or other data. The processor on the smart card may be capable of performing other operations as well.

In telephony systems that use Global System for Mobile communications (GSM) standard, a Subscriber Interface Module (SIM) card may be implemented using smart card technologies. A SIM card may store a phone number as well as encryption keys and other information on the storage mechanism within the SIM card. In many cases, a phone address book, instant message history, and other information may be stored on the SIM card.

Smart card technologies typically use a primitive data storage scheme. A smart card may have an Electrically Erasable Programmable Read Only Memory (EEPROM) or other device that may contain a single top level file called a Master File (MF). The MF may have Dedicated Files (DF) that may be organized below the MF in a hierarchical fashion. Elementary Files (EF) are stored under the DF. Each file within an MF/DF/EF file structure may be identified with a File ID (FID) that may be 2 bytes long.

Communication with a smart card is typically performed using a protocol that uses Application Protocol Data Unit (APDU) or another packet based communication protocol. APDU is defined in ISO/IEC 7816 standards. APDU is a packet based communication protocol, where a command is encapsulated into a 5-byte header and up to 255 bytes of data and sent to the smart card. A response generated by the smart card contains a 2-byte status word and up to 256 bytes of data.

The APDU communication protocol operates in many different devices and implementations. However, the APDU communication protocol is a relatively low level protocol and the MF/DF/EF files structure within a smart card is managed at a very low level. Such systems may have an advantage at being simple and using low overhead, but such systems become difficult to manage when using higher level software constructs and high level languages.

### SUMMARY

An application programming interface (API) may receive high level file commands and implement those commands using the storage mechanism on a smart card. The smart card may have a processor and storage mechanism and may communicate to a host device using a packet based communication protocol, such as ADPU. The API may translate the high level file commands into one or more ADPU commands, communicate with the smart card, receive APDU responses, and translate the responses into high level file commands. A high level file command may allow access to a file using long file names, a hierarchical directory structure, and may allow creating, writing, reading, and deleting a file. Some embodiments may have more complex functions for navigating and manipulating a hierarchical directory structure, as well as defining metadata including access privileges and file types to individual files.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a device with a file system storage on a smart card.

FIG. 2 is a timeline illustration of an embodiment showing a method of interaction between an application, application programming interface, and a smart card.

### DETAILED DESCRIPTION

An application programming interface (API) may provide a file-like interface to smart cards. The API may accept several different file commands and may store information on a smart card using the smart card's storage mechanism, while communicating to the smart card using a packet based communication protocol. Applications that use the API may be able to manipulate data on the smart card using familiar file nomenclature and operations, rather than having to use a low level protocol such as APDU typically used in smart cards.

A smart card may be a device that contains a processor and some data storage. In many applications, a smart card may have a processor that may handle communications on an interface, as well as perform various cryptographic processes.

Smart card technology may be governed by several standards, including ISO/IEC 7810, ISO/IEC 7816, and other standards. Some smart cards may not comply with such standards. Contact smart cards may be those smart cards that have several contact pads through which a host device may power the smart card and communicate with the smart card. Contactless smart cards may be those smart cards that may communicate using RFID technology or other wireless technology. Some contactless smart cards may comply with ISO/IEC 14443 or another standard. Some contactless smart cards may not comply with any standard.

Typically, smart cards may use a low level protocol such as Application Protocol Data Unit (APDU), as defined in ISO/IEC 7816 standard. APDU is a protocol by which commands may be sent to a smart cards and responses received. In many instances, the communications using APDU may be bit-level or byte-level commands that may be tedious to implement.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

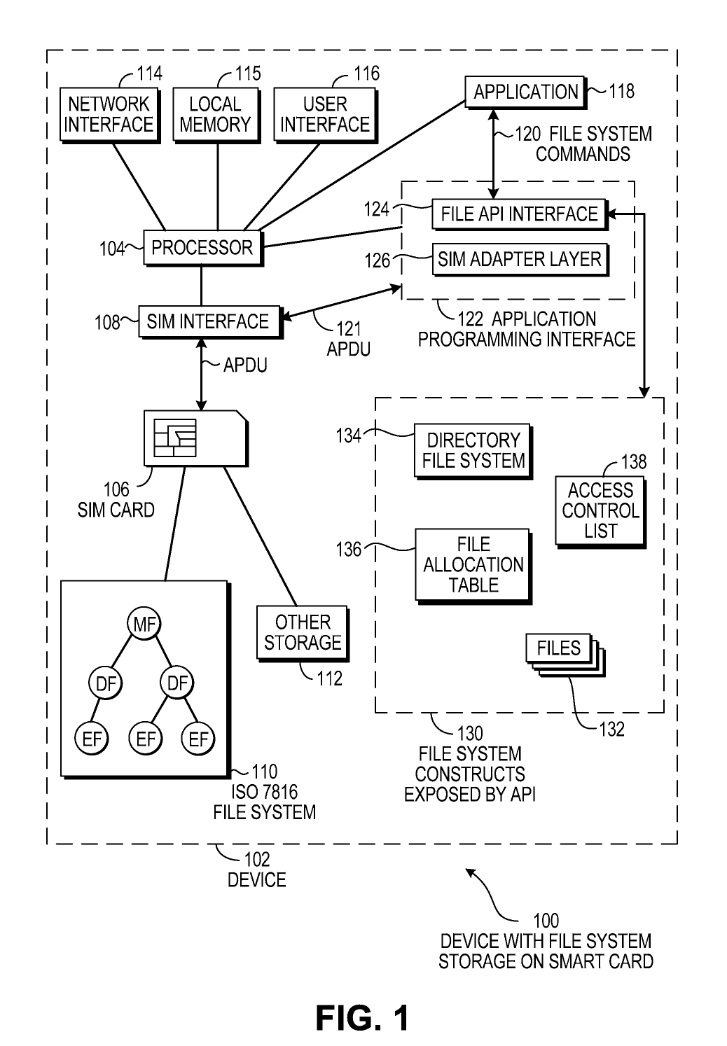

FIG. 1 is a diagram of an embodiment 100 showing a system that may provide file system functions to applications for data that are stored on a smart card. Embodiment 100 is a simplified example of both hardware and software stacks that may be used to provide file services for smart card storage.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of hardware and software components that may be used to provide file system commands to an application for data stored on a smart card. In many embodiments, the data stored on a smart card may be accessed using low level commands. Many smart cards use a packet based communication protocol, such as APDU, which do not provide file system command support.

Embodiment 100 is a representation of a hardware stack on the left hand side and a software stack on the right hand side. The illustration of embodiment 100 shows only some components that may make up the hardware and software components of the device 102.

File system command support may be a set of commands that may allow an application to store and manipulate data on a smart card using high level file manipulation techniques. For example, files may be created and named using descriptive names, placed into a hierarchy of directories, manipulated within those directories, as well as conventionally reading and writing data to the files.

File system commands may allow a programmer to manipulate data on a smart card without having to learn and understand the underlying storage mechanisms or communication protocols that may be used to store information on a smart card. The file abstraction may enable a programmer who is familiar with a high level language to program in that language and to use constructs with which the programmer may be familiar.

Device 102 is illustrated in embodiment 100. Device 102 may have a processor 104 and a SIM card 106. The SIM card 106 may be accessed using a SIM interface 108. A SIM card 106 is a particular embodiment of a smart card, where the smart card may serve as a Subscriber Identity Module (SIM), commonly deployed in Global System for Mobile communications (GSM) mobile telephony devices.

Throughout this specification, a SIM card is used as a particular instance of a smart card. Many of the features, attributes, uses, and functionality of a SIM card may apply to any smart card, and many of the features, attributes, uses, and functionality of a smart card may apply to a SIM card. A SIM card may be a smart card that has specific functionality and data that allow the smart card to operate within a GSM network.

Many different mobile phones may have an architecture similar to embodiment 100. Within a typical GSM phone, a SIM card may be a removable smart card that contains the subscriber's identity in the form of encryption keys, electronic identification, and other data. The SIM card may perform some cryptographic processing using the encryption keys to verify the identity of a mobile phone when the mobile phone establishes a connection to a cellular telephony network.

In many cellular telephones, the SIM card may be used to store data. For example, a list of phone book contacts, multiple phone numbers, histories of instant message transmissions, and other data may be stored on the SIM card.

Many other devices may use a smart card. In one use scenario, a computer system may use smart cards as part of the authentication for individual users. In one example of such a system, a company or enterprise may issue smart cards to each employee. Various computers within the enterprise may have a smart card reader that may be used in lieu of or in addition to user name and password credentials. In some embodiments, a smart card may be part of a user's credentials when accessing sensitive data from a remote location, for example.

A smart card may be used to store data in many cases. For example, smart cards may be issued to riders in a public transportation system. Each rider may purchase a smart card with a certain amount of credits or currency stored on the card. As a rider uses a public transportation system, the stored currency or credits may be deducted from the amount stored on the card.

When smart cards are used as credentials, the smart cards may contain data that is personal to the user. For example, a user who uses multiple devices may have the user's work assignment in the form of a spreadsheet stored on the smart card. Any time the user accesses a device with the smart card, the spreadsheet data may be available locally. In another example, a smart card may store various biometric data about a user, such as fingerprints, retinal scans, photographs, or other information. When a user wishes to gain access to a locked door, for example, a device may perform a fingerprint or retinal scan, compare the scanned image to the stored image, and unlock the door if the images match.

In a smart phone embodiment, a device 102 may have large amounts of data that may be stored on the SIM card 106. The data may be data used by the phone, such as address books, and the data may be other data that is accessed by applications 118. In some smart phones, the applications 118 may include media players, word processing programs, email programs, and many other applications, each of which may use or manipulate some form of data that may be stored on the SIM card 106.

The SIM card 106 may contain various types of data storage. An illustration of an ISO 7816 file system 110 is shown along with another type of storage 112. The ISO 7816 file system 110 may be defined using a primitive data storage scheme. A smart card may have an Electrically Erasable Programmable Read Only Memory (EEPROM) or other device that may contain a single top level file called a Master File (MF). The MF may have Dedicated Files (DF) that may be organized below the MF in a hierarchical fashion. Elementary Files (EF) are stored under the DF. Each file within an MF/DF/EF file structure may be identified with a File ID (FID) that may be 2 bytes long.

In order to interact with such a file system, several APDU commands may be used. For example, one APDU command may be used to select a file either by name or by location within an MF/DF/EF hierarchy. A second APDU command may be used to read from the file either reading a set of binary data or reading a record within the file.

The SIM card 106 may have a different data storage mechanism represented by the other type of storage 112. The storage 112 may use any type of data storage format and may be accessed using extensions to an APDU protocol. In some cases, the storage 112 may have a different arrangement, format, and architecture than the ISO 7816 file system 110 and may be accessed using different commands and procedures.

The processor 104 may have connections to a network interface 114. In the case of a mobile phone, the network interface 114 may be a radio frequency connection to a cellular telephony network. Many embodiments may have hardwired connections to Ethernet or another wired network, and some embodiments may have wireless connections such as IEEE 802.11 (WiFi), IEEE 802.16 (WiMAX), Bluetooth, IrDA, or other connections. In some embodiments, a device may have two or more different wired or wireless connections to a network.

The processor 104 may have local memory 115. The local memory 115 may be a volatile random access memory that is used to store the executing commands for an application 118 as well as data used by the application 118. Some devices may use non-volatile memory for storing executing commands and application data. Typically, memory used for executing commands and application data may be high speed memory technologies.

In some embodiments, the local memory 115 may include non-volatile storage, such as hard disk storage, solid state disk storage, or other mass storage. Such mass storage may be used for storing large amounts of application data, application code, and other information.

In the software stack illustrated on the right hand side of FIG. 1, an application 118 may communicate with an application programming interface 122 using file system commands 120. The application programming interface 122 may store information on the SIM card 106, but may expose several file system constructs 130. The file system commands 120 may add, remove, and manipulate data stored on the SIM card 106 by using some of the file system constructs 130 or the effects of the file system constructs 130.

In order to expose the file system constructs 130, the application programming interface may convert the file system commands 120 into APDU commands 121 that are transmitted to and operated upon by the SIM card 106.

The application programming interface 122 may comprise two layers. The file API interface 124 may receive file system commands 120 and may convert the commands to an intermediate set of instructions. A SIM adapter layer 126 may receive the intermediate set of instructions and create APDU commands 121 that are sent to the SIM card 106.

In many cases, different vendors may create SIM cards 106 having different instruction sets and different storage capabilities. Each vendor may create a SIM adapter layer 126 that may plug into the application programming interface 122 and customize the application programming interface 122 for the particular instruction set and storage capabilities. In some cases, different styles, formats, or standards may be used between different models of SIM cards. For each model of SIM cards, a specific SIM layer adapter 126 may be used.

The file system commands 120 sent from the application 118 to the application programming interface 122 may allow the application 118 to manipulate data in a manner similar to operating system files. Some embodiments may have a subset or superset of capabilities discussed herein.

The file system commands 120 may allow an application 118 to use long filenames to identify files. The MF/DF/EF file system 110 may permit files to be named with only 2 bytes. In contrast, the file system commands 120 may allow a file to be named using a more user friendly file naming convention.

For example, some implementations may allow a file name of 8 characters. Other implementations may allow a file name of 255 or more characters. Typically, a character may be represented in a single byte of data. This means that an MF/DF/EF file system 110 may only allow file names that are two characters long.

In order to implement long file names, some embodiments may create a file allocation table 136. In one implementation, the file allocation table 136 may map a long file name used by the file system commands 120 to files within an MF/DF/EF file system 110. In another implementation, the file allocation table 136 may be used to map long file names to files or records that may be stored in another data structure 112.

Some embodiments may create and maintain a file allocation table 136. Other embodiments may implement long file names using a different technique and may not create and maintain an actual file allocation table 136.

Some implementations may allow a file type to be associated with a file name. Some implementations may limit a file name to 8 characters and a file type to 3 characters. Other implementations may not have such restrictions.

A file type may be used by an application or operating system to determine what actions may be permitted with the file or how the file may be formatted. In some embodiments, selecting a file with a specific extension or file type may launch an appropriate application that may process the file. For example, a user may select a file with a word processor file type, and a word processor application may be launched and the selected file may be loaded.

In some embodiments, a file type may be specified in the file name, separated by a period. For example, the file name “foo.exe” may have a file name of “foo” with an extension or file type of “exe”.

Many embodiments may implement a hierarchical or directory file system 134. In some implementations, one or more file allocations tables 136 may be used to create a directory file system 134. When a directory file system 134 is implemented, the file system commands 120 may include commands for creating, modifying, and deleting a hierarchical structure, as well as navigating the structure. Commands may include creating directories, naming and renaming directories, moving directories, and assigning metadata to individual directories.

The file system commands 120 may include many conventional file operations. Such operations may include creating and deleting files, reading all or a portion of a file, defining specific types of files, appending to a file, removing content from a file, and other operations.

The file system commands 120 may allow certain metadata to be stored along with the file. In some embodiments, the metadata may include a file name, a file length, file creation time, last time a file was accessed, file type, and other metadata. The file length may be defined by the number of blocks occupied by the file, the number of bytes consumed, or some other measure. In some embodiments, the file type may define if the file is a subdirectory in the hierarchical file system.

In some embodiments, the file system commands 120 may include atomic operations that may commit a file change to the file in a single operation. Atomic operations may be used when performing transactions that may be either completely able to be finished or reversed at any point during the transaction. An example may be updating a financial account where, if the operation should fail at any point, the transaction may be reversed or completed without losing or corrupting data.

Some embodiments may employ access control lists 138 that may define various limitations on access to individual files or directories. The access may be limited to particular users, processes, applications, or other objects. In some cases, the access to an object may be defined by the object's membership in a group, such as may be found in various role based access control schemes.

An access control list may contain a description of which users may be permitted access to a particular file or directory. In many cases, the access control list may be defined to separately allow reading, writing, executing, renaming, deleting, and other operations for individual users. For example, a first user may be allowed full control of a file and may be able to perform any operation on a file. A second user may be allowed read only access, but not write access or other types of access.

In a role based access control system, a user may be assigned an administrator role and may be permitted full access by virtue of his membership in the administrator group. Another user may be assigned to a user group that may permit read/write access but may not permit the user to delete the file, for example.

The files 132 made available through the file system commands 120 may have capabilities or features that are not found in the primitive file systems that may be in the ISO 7816 file system 110 or the other storage 112. One of the differences may be in file size. In some implementations, the files 132 may be much larger than the permitted size of a file using the APDU commands 121. However, the application programming interface 122 may expose a single, large file to the file system commands 120 while maintaining several smaller files on the ISO 7816 file system 110 or other storage 112. The application programming interface 122 may manage multiple files or other storage records on the SIM card 106 to present the single file to the file system commands 120.

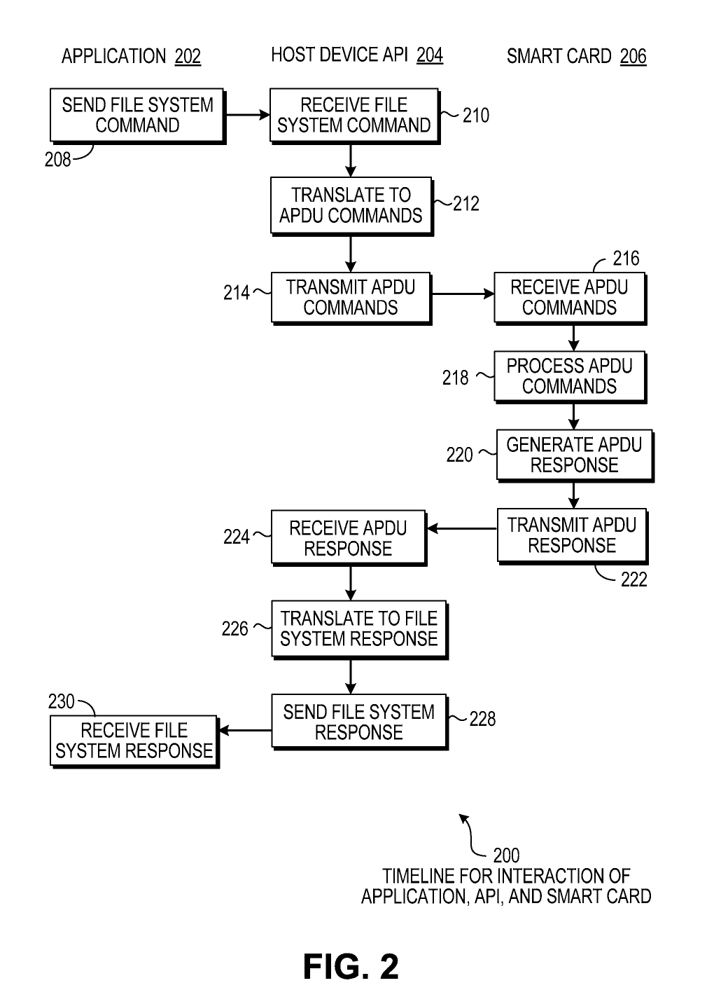

FIG. 2 is a timeline illustration of an embodiment 200 showing a sequence for processing a file system command. Embodiment 200 is a simplified example of a method where an application 202, a host device application programming interface 204, and a smart card 206 may interact when processing a file system command. The actions of the application 202 may correspond with the application 118 of embodiment 100. Similarly, the actions of the application programming interface 204 may correspond with the application programming interface 122 of embodiment 100, as the actions of the smart card 206 may correspond with the actions of the SIM card 106 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a simplified exchange between an application 202, an application programming interface 204, and a smart card 206. The application 202 may send file system commands in block 208 and receive file system responses in block 230. The application programming interface 204 may cause the commands to be executed by the smart card 206.

The application 202 may send various file system commands in block 208. In many embodiments, the file system commands may refer to a file using a long file name. Long files names are typically not supported in smart cards, and thus the application programming interface 204 may perform some operations to handle long file names. For example, a file allocation table may be created on a smart card 206 with records comprising a long file name and a two-byte file name for a corresponding file on the smart card 206.

In one command in block 208, an application 202 may issue a write command using a long file name, for example. The file command may be received in block 210 and translated into APDU commands in block 212. The APDU commands may be transmitted in block 214 to the smart card 206.

The example of a write command to a file using a long file name may be translated into several APDU commands. For example, a set of APDU commands may be generated to select, open, and search a file allocation table for a local file name corresponding to the long file name. Using the local file name, the file may be selected, open, and a write command may be performed. In the example, possibly six or more APDU commands may be created by the application programming interface 204 to implement a single file system command received in block 210.

The file system commands may comprise basic file operations, such as creating, deleting, reading, and writing. In many embodiments, long file names, file extensions, and other features of an operating system-like file system may be permitted.

The file system commands may comprise operations relating to a file hierarchy. For example, the commands may include creating, renaming, moving, and manipulating subdirectories in a hierarchical manner, as well as addressing files within a hierarchy.

The file system commands may comprise setting and retrieving metadata about files. The metadata that may be retrieved may include a file size, file creation time, last time a file was accessed, and other metadata. Some metadata may be configurable or settable by command, including a file type, whether the file is executable or not, access permission settings, a file owner, a file author, or other metadata.

In some embodiments, the file system commands in block 208 may set access permissions to a file. In many cases, an access control list may be maintained to grant or deny certain privileges for specific users of a file. For example, a first user may be permitted read and write access while a second user may be permitted read only access.

In block 212, the file system commands may be translated to APDU commands. In some embodiments, the commands sent to the smart card 206 may other types of packet based commands. The commands may be APDU commands, extensions of an APDU command set, or other types of commands. Embodiment 200 illustrates APDU commands, but other commands may also be used.

After the APDU commands are created in block 212, the commands may be transmitted by the application programming interface in block 214.

The APDU commands may be received by the smart card 206 in block 216, processed in block 218, and a response generated in block 220. The response may be transmitted in block 222.

The APDU response may be received by the application programming interface 204 in block 224, and a file system response may be generated in block 226. The file system response may be transmitted in block 228 and received by the application 202 in block 230.

Embodiment 200 illustrates a flow of a single command that may be generated by an application programming interface 204, processed by a smart card 206, and the response returned to the application programming interface 204. In some instances, a single file system command may be sent by an application 202, which may cause multiple commands to be issued by the application programming interface 204 and processed by the smart card 206. In some cases, the commands may reflect a complex process flow of APDU commands that may be performed in order to satisfy a single file system command.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a first processor in a host device;
a second device connected to said host device, said second device comprising:
a second processor;
a storage mechanism; and
an interface for communicating using a packet based communication language;
an application programming interface operable on said first processor and configured to:
present at least a portion of said storage mechanism on said second device as a file system;
receive a file system command;
translate said file system command to a first communication packet complying with said packet based communication language;
transmit said first communication packet to said second device;
receive a response from said second device, said response comprising a second communication packet complying with said packet based communication language;
translate said response into a file system response; and
present said file system response in response to said file system command.

2. The system of claim 1, said packet based communication language being based at least in part on APDU.

3. The system of claim 1, said second device being a smart card in at least partial compliance with ISO 7810.

4. The system of claim 1, said interface being the only communications interface with said second device.

5. The system of claim 1, said host device being a mobile phone.

6. The system of claim 5, said second device comprising a subscriber interface module.

7. The system of claim 6, said second device having a file allocation table stored in said storage mechanism.

8. The system of claim 7 said second device having an access control list stored on said storage mechanism.

9. A method comprising:
receiving a file system command, said file system command referencing a file name longer than 2 bytes;
translating said file system command to a first communication packet complying with ADPU;
transmitting said first communication packet to a second device, said second device comprising:
a processor;
a storage mechanism; and
a communications interface that communicates using said ADPU;
receiving a response from said second device, said response comprising a second communication packet complying with said ADPU;
translating said response into a file system response; and
presenting said file system response in response to said file system command.

10. The method of claim 9, said file system command being one of a group composed of:
writing to a file;
reading from a file:
creating a file; and
deleting a file.

11. The method of claim 9, said file system command comprising setting a file type.

12. The method of claim 11, said file type comprising one of a group composed of:
executable file; and
data file.

13. The method of claim 9, said file system command comprising renaming a file.

14. The method of claim 9, said file system command referring to a hierarchical file structure.

15. The method of claim 14, said file system command comprising moving a file within said hierarchical file structure.

16. The method of claim 9, further comprising translating said file system command to a plurality of communication packets complying with said ADPU.

17. A device comprising:
a first processor operable to execute a software application;
an interface to a smart card, said interface using a communication protocol compliant with ADPU, said smart card having a second processor and a storage mechanism;
an application programming interface configured to accept file system commands from said software application and return file system responses to said software application, said application programming interface performing a method comprising:
receiving said file system command, said file system command referencing a file name longer than 2 bytes;
translating said file system command to a first communication packet complying with ADPU;
transmitting said first communication packet across said interface;
receiving a response across said interface, said response comprising a second communication packet complying with said ADPU;
translating said response into a file system response; and
presenting said file system response to said software application in response to said file system command.

18. The device of claim 17 being a mobile telephony device.

19. The device of claim 18, said smart card comprising a Subscriber Interface Module.

20. The device of claim 19, said file name being longer than 32 bytes.
